(19) United States
(12) Patent Application Publication
(10) Pub. No.: US 2007/0151108 A1
(43) Pub. Date: Jul. 5, 2007

(54) Safety razor apparatus having an adjustable guiding member

(75) Inventors: Willem Auke Westerhof, Drachten (NL); Robert Alexander Van Eibergen Santhagens, Drachten (NL); Everhardus Johannes Hoexum, Drachten (NL); Ype Bernardus Brada, Drachten (NL); Peter Hans Van Der Vlis, Drachten (NL); Dirk Hendrik Wevers, Drachten (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V. A CORPOATION

(21) Appl. No.: 10/587,449

(22) PCT Filed: Jan. 13, 2005
(86) PCT No.: PCT/IB05/50146

§ 371 Date: Jul. 25, 2006

(30) Foreign Application Priority Data
Jan. 26, 2004 (EP) 04100266.8

(51) Int. Cl. B26B 21/00

(52) U.S. Cl. 30/50

(57) ABSTRACT

A safety razor apparatus having a blade assembly (2) comprising two guiding members (9, 10), each having a surface for abutting against a skin, and one or more blades (11, 12, 13) being located between said two guiding members (9, 10). The cutting edge (14) of each blade (11, 12, 13) and said surfaces are positioned substantially in one plane (20). The apparatus has a grip portion (1) being connected to said blade assembly (2). The position of at least one of the two guiding members (9, 10) is adjustable in a direction perpendicular to said plane (20).

The invention relates to a safety razor apparatus having a blade assembly comprising two guiding members, each having a surface for abutting against a skin, and one or more blades being located between said two guiding members, wherein the cutting edge of each blade and said surfaces are positioned substantially in one plane, and the apparatus having a grip portion being connected to said blade assembly.

The invention also relates to a blade assembly for a safety razor apparatus, comprising two guiding members, each having a surface for abutting against a skin, and one or more blades being located between said two guiding members, wherein the cutting edge of each blade and said surfaces are positioned substantially in one plane

A safety razor apparatus and a blade assembly of the kinds mentioned in the opening paragraphs are generally known. In the case of more than one blade, the respective cutting edges are positioned parallel to one another. Preferably there are at least two blades. Furthermore, preferably the guiding member, which abuts against the skin in front of the blades during operation, is a skin stretching member. Between the skin and the surface of said skin stretching member there is a relatively high friction when the surface is pushed against the skin. As a result, the skin is stretched in order to facilitate the shaving action of the blades. The guiding member abutting the skin behind the blades is preferably a lubrication member. The friction between the skin and the surface of said lubrication member is relatively low. The lubrication member may contain a lubrication substance or the like.

In a number of known safety razor apparatus the grip portion is attached to the blade assembly in a fixed position, however, preferably, the grip portion can hinge or pivot with respect to the blade assembly around a pivot axis parallel to said cutting edge. Preferably the pivot axis is located near said one plane, and substantially between the two guiding members, preferably in front of the cutting edge of the first blade. As a result, the blade assembly is in a stable position when it is pushed against the skin by the grip portion of the razor apparatus.

The position of the blades, and in particular the position of the cutting edges of the blades, in relation to the other parts of the blade assembly, in particular the guiding members, determines the shaving geometry of the razor apparatus. The cutting edges are located substantially in said plane through said surfaces of the two guiding members, that is to say, the cutting edges are located in said plane or near said plane.

An important parameter in the shaving geometry is the extent to which the blades extend in a direction away from the blade assembly. Although the cutting edges are still located substantially in the said one plane, they can extend more or less in a direction away from the blade assembly by having different distances to said one plane. Thereby a relatively small change in the position of the cutting edges of the blades results already in a major change in the shaving behavior of the razor apparatus. In practice it has been found that different persons have different desires as to the shaving behavior of the razor apparatus. Although each person will have a preferred geometry of the razor apparatus, also different parts of the face of the shaving person may require different geometries of the razor apparatus. Furthermore, the frequency of the shaving operation, i.e. the length of the beard, may have an influence on the desired geometry.

An object of the invention is to provide a safety razor apparatus and a blade assembly for use therein, by means of which the shaving geometry, in particular the location of the cutting edges of the blades relative to the other parts of the blade assembly, can easily be adjusted by the shaving person.

In order to achieve this object, a safety razor apparatus in accordance with the invention is characterized in that the position of at least one of the two guiding members is adjustable in a direction perpendicular to said plane.

In order to achieve this object, a blade assembly in accordance with the invention is characterized in that the position of at least one of the two guiding members is adjustable in a direction perpendicular to said plane.

When displacing one of the guiding members, the location of the said plane with respect to the cutting edges changes, and thereby the distance between the cutting edges of the blades and said plane changes. Therefore, the extent to which the cutting edges of the blades extend in a direction away from the blade assembly is adjusted. As a certain displacement of one of the guiding members results in a much smaller change in the location of the cutting edges with respect to said one plane, the relative position of the cutting edges can be adjusted quite precisely by moving one of the guiding members.

In one preferred embodiment, the guiding member which is present in front of the blades, seen in a shaving direction of the apparatus, is a skin stretching member, and the guiding member which is present behind the blades, seen in a shaving direction of the apparatus, is a lubrication member, wherein the lubrication member is the adjustable guiding member. In case the lubrication member will wear in time due to the shaving operation, adjustment of the lubrication member can compensate such wear.

In one preferred embodiment, the adjustable guiding member can be fixed in two positions with respect to the blade assembly, and preferably the guiding member can be fixed in at least one position between said two positions, more preferably in any position between said two positions.

Preferably, the surface of said at least one of the guiding members can be fixed in a position in said one plane and in a position at some distance from said one plane in a direction away from said blade assembly. In the first position the cutting edges and both surfaces are located in said one plane, and in the second position the surface of the adjustable guiding member is located near said one plane, but still substantially in said one plane. Such second position results in a less aggressive shaving behavior of the razor apparatus.

In one preferred embodiment, only one of said two guiding members is adjustable, which is preferably the lubrication member. The lubrication member abuts the skin behind the cutting edges of the blades, and often the distance between the lubrication member and the cutting edges is larger than the distance between the stretching member and the cutting edges. In that case, a displacement of the surface of the lubrication member results in a much smaller relative movement of the cutting edges of the blades.

Preferably, the guiding member can be displaced over a distance of more than 0.3 mm, preferably more than 0.5 mm. Such a relatively large displacement provides for a sufficient degree of adjustment of the configuration of the blade assembly.

In one preferred embodiment, the adjustable guiding member is movably accommodated in an encasing frame, which frame is a part of the blade assembly, wherein said surface of the adjustable guiding member extends outside said frame, the frame being provided with spring means for pushing the guiding member into the frame against movable adjustment means located inside said frame. Preferably, said adjustment means can be displaced in a direction parallel to the cutting edge, and an inclined surface of said adjustment means cooperates with a corresponding inclined surface of the adjustable guiding member, so that the adjustable guiding member moves perpendicularly to the direction of movement of said adjustment means. This configuration will be further elucidated hereinafter referring to an example of a safety razor apparatus.

An embodiment of a safety razor apparatus and a blade assembly in accordance with the invention will be explained in the following, and reference is made to the drawing, in which:

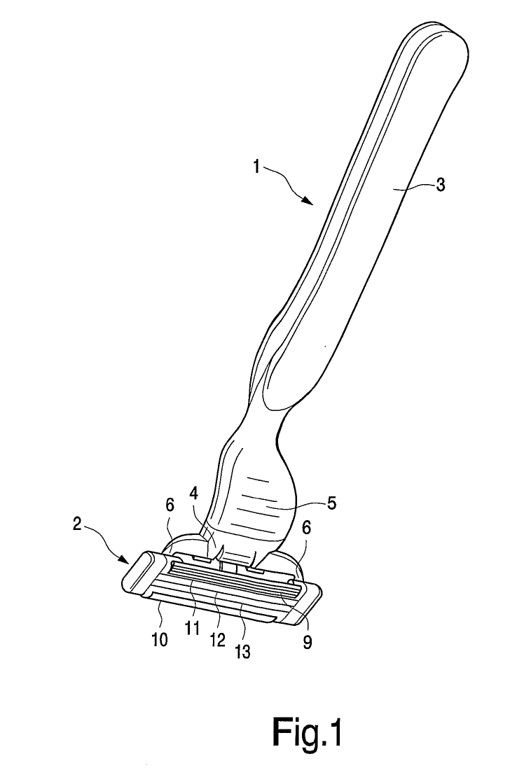

FIG. 1 is a perspective view of a safety razor apparatus in accordance with the invention;

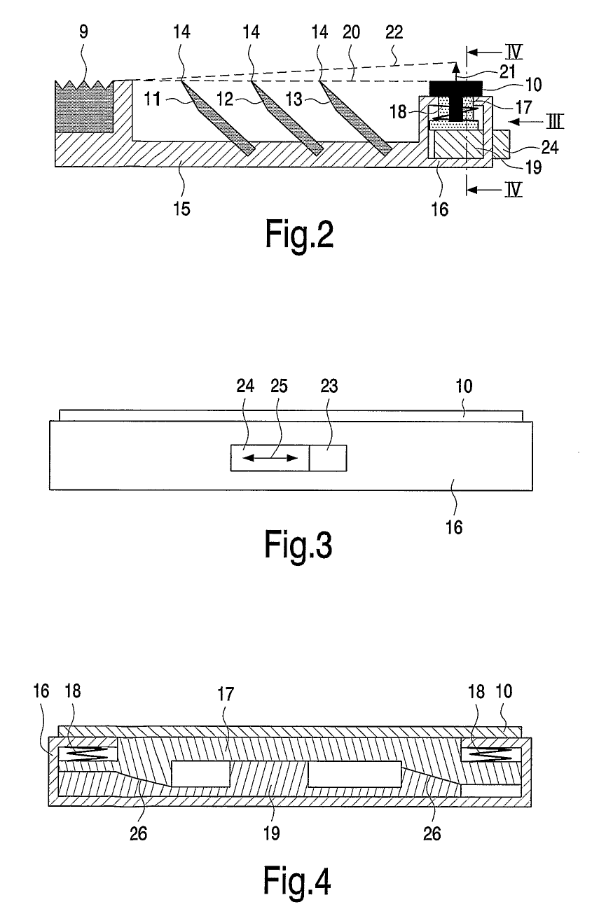

FIG. 2 is a schematic sectional view of a blade assembly in accordance with the invention, as used in the apparatus of FIG. 1;

FIG. 3 is a side view according to arrow III in FIG. 2; and

FIG. 4 is a sectional view along line IV-IV in FIG. 2.

The Figures, in particular FIGS. 2, 3 and 4, are very schematic drawings representing only parts which are important for a good understanding of the embodiment of the safety razor apparatus.

As shown in FIG. 1, an embodiment of a safety razor apparatus in accordance with the invention is provided with a grip portion 1 and a blade assembly 2. The grip portion 1 comprises a part 3 that can be held by the hand of a shaving person, and a part 4 provided with a hinging or pivoting connection with the blade assembly 2. Between part 3 and part 4, the grip portion 1 comprises a broadened part 5 having a larger width than said part 3.

Part 4 of the grip portion 1 is provided with two arms 6. Between the ends of the arms 6 there is a pin (not shown in the Figure), which pin is engaged by the blade assembly 2. The pin forms the pivot axis for the blade assembly 2.

The blade assembly 2 is provided with a first guiding member, in the embodiment shown a skin stretching member 9, and with a second guiding member, in the embodiment shown a lubrication member 10. Between the skin stretching member 9 and the lubrication member 10 there are three blades 11, 12, 13 having three parallel cutting edges 14 (see FIG. 2). The three blades 11-13 are mounted in a fixed position in the blade assembly 2 and the edges 14 are positioned substantially in a plane through the surface of the stretching member 9 and the surface of the lubrication member 10. During the shaving operation the skin is substantially located in that plane.

FIG. 2 is a very schematic sectional drawing of the blade assembly 2. The blade assembly 2 comprises a base 15, which is made of plastic material. The stretching member 9 and the blades 11 to 13 are fixed to the base 15. The base 15 furthermore comprises the frame 16 encasing a holder 17 to which the lubrication member 10 is attached by means of clamping means. The holder 17, together with the lubrication member 10, is pushed downward inside the holder 17 by spring means 18, against adjustment member 19. Therefore the lubrication member 10 is maintained in the position as shown in FIG. 2, wherein the three edges 14 of the blades 11 to 13 and the surfaces of the stretching member 9 and the lubrication member 10 are all located in a plane indicated by means of striped line 20.

As is shown by arrow 21, the lubrication member 10 can be displaced upwardly, as a result of which the holder 17 is moved upwardly against the force of the spring means 18. In that upward position of lubrication member 10, the plane through the surfaces of the stretching member 9 and the lubrication member 10 moves slightly upward, as indicated by striped line 22. It will be clear from FIG. 2 that thereby the cutting edges 14 of the blades 11 to 13 are located at some distance from said plane 22. Relative to the stretching member 9 and the lubrication member 10 the cutting edges 14 are retracted a little into the blade assembly 2, providing for a less aggressive shaving behavior of the safety razor apparatus.

It is hereby emphasized that the distance between the cutting edges 14 and the plane 22 remains small, so that it can still be said that the surfaces of the stretching member 9 and the lubrication member 10 as well as the cutting edges 14 of blades 11 to 13 are located substantially in the same plane (20 and 22 respectively).

FIG. 3 is a side view according to arrow III in FIG. 2. It shows the lubrication member 10 and the encasing frame 16. The encasing frame 16 is provided with a rectangular opening 23, through which a handle 24 extends outside said frame 16 (see also FIG. 2). The lubrication member 10 can be displaced by moving handle 24 in the direction as indicated by arrow 25.

FIG. 4 is a sectional view according to the line IV-IV in FIG. 2. The lubrication member 10 projects from the encasing frame 16. Lubrication member 10 is attached to holder 17, and holder 17 is pushed against adjustment member 19 by two helical springs 18. It will be clear that by moving adjustment member 19 in the right direction, the inclined surfaces 26 will displace the holder 17, and thereby the lubrication member 10, in upward direction. Adjustment member 19 can be moved by means of handle 24, which handle 24 is a part of adjustment member 19.

The inclination of the surfaces 26 and the material of the holder 17 and the adjustment member 19 are chosen in such a way that the friction between the two contacting surfaces 26 prevents relative movement of the surfaces 26 when no external force is exerted. However, by moving handle 24 the lubrication member 10 can be placed in any desired position.

1. A safety razor apparatus having a blade assembly comprising two guiding members each having a surface for abutting against a skin, and one or more blades being located between said two guiding members, wherein the cutting edge of each blade and said surfaces are positioned substantially in one plane, and the apparatus having a grip portion being connected to said blade assembly, characterized in that the position of at least one of the two guiding members is adjustable in a direction perpendicular to said plane.

2. A safety razor apparatus as claimed in claim 1, characterized in that the guiding member which is present in front of the blades, seen in a shaving direction of the apparatus, is a skin stretching member, and the guiding member which is present behind the blades, seen in the shaving direction, is a lubrication member, wherein the lubrication member (10) is the adjustable guiding member.

3. A safety razor apparatus as claimed in claim 2, characterized in that the adjustable guiding member can be fixed in two positions with respect to the blade assembly.

4. A safety razor apparatus as claimed in claim 3, characterized in that the adjustable guiding member can be fixed in at least one position between said two positions, preferably in any position between said two positions.

5. A safety razor apparatus as claimed in claim 1, characterized in that the surface of said at least one of the guiding members can be fixed in a position in said one plane and in a position at some distance from said one plane in a direction away from said blade assembly.

6. A safety razor apparatus as claimed in claim 1, characterized in that only one of said two guiding members is adjustable.

7. A safety razor apparatus as claimed in claim 6, characterized in that the adjustable guiding member is movably accommodated in an encasing frame which frame is a part of the blade assembly, wherein said surface of the adjustable guiding member extends outside said frame the frame being provided with spring means for pushing the guiding member into the frame against movable adjustment means.

8. A safety razor apparatus as claimed in claim 7, characterized in that said adjustment means can be displaced in a direction parallel to said cutting edge wherein an inclined surface of said adjustment means cooperates with a corresponding inclined surface of the adjustable guiding member, so that the adjustable guiding member moves perpendicularly to the direction of movement of said adjustment means.

9. A blade assembly for a safety razor apparatus, comprising two guiding members each having a surface for abutting against a skin, and one or more blades being located between said two guiding members wherein the cutting edge of each blade and said surfaces are positioned substantially in one plane characterized in that the position of at least one of the two guiding members is adjustable in a direction perpendicular to said plane.
